(19) United States
(12) Patent Application Publication
(10) Pub. No.: US 2010/0060783 A1
(43) Pub. Date: Mar. 11, 2010

(54) PROCESSING METHOD AND DEVICE WITH VIDEO TEMPORAL UP-CONVERSION

(75) Inventor: Harm Jan Willem Belt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/995,017

(22) PCT Filed: Jul. 7, 2006
(86) PCT No.: PCT/IB06/52296

§ 371 Date: Jan. 8, 2008

(30) Foreign Application Priority Data
Jul. 13, 2005 (EP) 05300594.8

(51) Int. Cl. H04N 7/01

(52) U.S. Cl. 348/441; 348/E07.003

(57) ABSTRACT

The present invention provides an improved method and device for visual enhancement of a digital image in video applications. In particular, the invention is concerned with a multi-modal scene analysis for face or people finding followed by the visual emphasis of one or more participants on the visual screen, or the visual emphasis of the person speaking among a group of participants to achieve an improved perceived quality and situational awareness during a video conference call. Said analysis is performed by means of a segmenting module (22) allowing to define at least a region of interest (ROI) and a region of no interest (RONI).

### FIELD OF THE INVENTION

The present invention relates to visual communication systems, and in particular, the invention relates to a method and device for providing temporal up-conversion in video telephony systems for enhanced quality of visual images.

### BACKGROUND OF THE INVENTION

In general terms, video quality is a key characteristic for global acceptance of video telephony applications. It is extremely critical and important that video telephony systems bring the situation at the other side as accurately as possible across to end users in order to enhance the user's situational awareness and thereby the perceived quality of the video call.

Although video conferencing systems have gained considerable attention since being first introduced many years ago, they have not become extremely popular and a wide breakthrough of these systems has not yet taken place. This was in general due to the insufficient availability of communication bandwidth leading to unacceptably low, poor quality of video and audio transmissions such as low resolution, blocky images and long delays.

However, recent technological innovations capable of providing sufficient communication bandwidth is becoming widely more available to an increasing number of end users. Further, the availability of powerful computing systems such as PC's, mobile devices, and the like, with integrated displays, cameras, microphones, speakers are rapidly growing. For these foregoing reasons, one may expect a breakthrough and higher quality expectations in the use and application of consumer video conferencing systems as the audiovisual quality of video conferencing solutions becomes one of the most important distinguishing factors in this demanding market.

Generally speaking, many conventional algorithms and techniques for improving video conferencing images have been proposed and implemented. For example, various efficient video encoding techniques have been applied to improve video encoding efficiency. In particular, such proposals (see, e.g., S. Daly, et al., “Face-Based Visually-Optimized Image Sequence Coding, 0-8186-8821-1/98, pages 443-447, IEEE) aim at improving video encoding efficiency based on the selection of a region of interest (ROI) and a region of no interest (RONI). Specifically, the proposed encoding is performed in such a way that most bits are assigned to the ROI and fewer bits are assigned to the RONI. Consequently, the overall bit-rate remains constant, but after the decoding, the quality of the ROI image is higher than the quality of the image in the RONI. Other proposals such as U.S. 2004/0070666 A1 to Bober et al. primarily suggest smart zooming techniques before video encoding is applied so that a person in a camera's field of view is zoomed in by digital means so that irrelevant background image portions are not transmitted. In other words, this method transmits an image by coding only the selected regions of interest of each captured image.

However, the conventional techniques described above are not often satisfactory due to a number of factors. No further processing or analysis is performed on the captured images to counter the adverse effects of image quality in the transmission of video communication systems. Further, improved coding schemes, although they might give acceptable results, cannot be applied independently across the board to all coding schemes, and such techniques require that particular video encoding and decoding techniques be implemented in the first place. Also, none of these techniques appropriately address the problems of low situation awareness and the poor perceived quality of a video teleconferencing call.

### SUMMARY OF THE INVENTION

Accordingly, it is an object of the present invention to provide a new and improved method and device that efficiently deals with image quality enhancement, which addresses the above mentioned problems, can be cost efficient and simple to implement.

To this end, the invention relates to a method of processing vidoe images that comprises the steps of detecting at least one person in an image of a video application, estimating the motion associated with the detected person in the image, segmenting the image into at least one region of interest and at least one region of no interest, where the region of interest includes the detected person in the image, and applying a temporal frame processing to a video signal including the image by using a higher frame rate in the region of interest than that applied in the region of no interest.

One or more of the following features may also be included.

In one aspect of the invention, the temporal frame processing includes a temporal frame-up conversion processing applied to the region of interest. In another aspect, the temporal frame processing includes a temporal frame down-conversion processing applied to the region of no interest.

In yet another aspect, the method also includes combining an output information from the temporal frame up-conversion processing step with an output information from the temporal frame down-conversion processing step to generate an enhanced output image. Further, the visual image quality enhancement steps can be performed either at a transmitting end or a receiving end of the video signal associated with the image.

Moreover, the step of detecting the person identified in the image of the video application may include detecting lip activity in the image, as well as detecting audio speech activity in the image. Also, the step of applying a temporal frame up-conversion processing to the region of interest may only be carried out when lip activity and/or audio speech activity has or have been detected.

In other aspects, the method also includes segmenting the image into at least a first region of interest and a second region of interest, selecting the first region of interest to apply the temporal frame up-conversion processing by increasing the frame rate, and leaving a frame rate of the second region of interest untouched.

The invention also relates to a device configured to process video images, where the device includes a detecting module configured to detect at least one person in an image of a video application; a motion estimation module configured to estimate a motion associated with the detected person in the image; a segmenting module configured to segment the image into at least one region of interest and at least one region of no interest, where the region of interest includes the detected person in the image ; and at least one processing module configured to apply a temporal frame processing to a video signal including the image by using a higher frame rate in the region of interest than that applied in the region of no interest.

Other features of the method and device are further recited in the dependent claims.

Embodiments may have one or more of the following advantages.

The invention advantageously enhances the visual perception of video conferencing systems for relevant image portions and increases the level of the situational awareness by making the visual images associated with the participants or persons who are speaking clearer relative to the remaining part of the image.

Further, the invention can be applied at the transmit end, which results in higher video compression efficiency because relatively more bits are assigned to the enhanced region of interest (ROI) and relatively less bits are assigned to the region of no interest (RONI), resulting in an improved transmission process of important and relevant video data such as facial expressions and the like, for the same bit-rate.

Additionally, the method and device of the present invention allows independent application from any coding scheme which can be used in video telephony implementations. The invention does not require video encoding nor decoding. Also, the method can be applied at the camera side in video telephony for an improved camera signal or it can be applied at the display side for an improved display signal. Therefore, the invention can be applied both at the transmit and receive ends.

As yet another advantage, the identification process for the detection of a face can be made more robust and fail proof by combining various face detection techniques or modalities such as a lip activity detector and/or an audio localization algorithms. Also, as another advantage, computations can be safeguarded and saved because the motion compensated interpolation is applied only in the ROI.

Therefore, with the implementation of the present invention, video quality is greatly enhanced, making for better acceptance of video-telephony applications by increasing the persons' situational awareness and thereby the perceived quality of the video call. Specifically, the present invention is able to transmit higher quality facial expressions for enhanced intelligibility of the images and for conveying different types of facial emotions and expressions. By increasing this type of situational awareness in current-day group video conferencing applications is tantamount to increased usage and reliability, especially when participants or persons on a conference call, for example, are not familiar with the other participants.

These and other aspects of the invention will become apparent from and elucidated with reference to the embodiments described in the following description, drawings and from the claims.

### BRIEF DESCRIPTION OF THE DRAWINGS

FIG. 1 is a schematic functional block diagram of one of the embodiments of an improved method for image quality enhancement according to the present invention;

FIG. 2 is a flowchart of one of the embodiments of the improved method for image quality enhancement according to FIG. 1;

FIG. 3 is a flowchart of another embodiment of the improved method for image quality enhancement according to the present invention;

FIG. 4 is a flowchart of another embodiment of the improved method for image quality enhancement according to the present invention;

FIG. 5 is a flowchart of another embodiment of the improved method for image quality enhancement according to the present invention;

FIG. 6 is a schematic functional block diagram of another embodiment of the improved method for image quality enhancement according to the present invention;

FIG. 7 is a schematic functional block diagram for image quality enhancement shown for a multiple person video conferencing session, in accordance with the present invention;

FIG. 8 is another schematic functional block diagram for image quality enhancement shown for a multiple person video conferencing session, in accordance with the present invention;

FIG. 9 is a flowchart illustrating the method steps used in one of the embodiments of the improved method for image quality enhancement, in accordance with FIG. 8;

FIG. 10 shows a typical image taken from a video application, as an exemplary case;

FIG. 11 shows the implementation of a face tracking mechanism, in accordance with the present invention;

FIG. 12 illustrates the application of a ROI/RONI segmentation process;

FIG. 13 illustrates the ROI/RONI segmentation based on a head and shoulder model;

FIG. 14 illustrates a frame rate conversion, in accordance with one of the embodiments of the present invention; and

FIG. 15 illustrates an optimization technique implemented in boundary areas between the ROI and the RONI area.

### DESCRIPTION OF THE PREFERED EMBODIMENTS

This invention deals with the perceptual enhancement of people in an image in a video telephony system as well as the enhancement of the situational awareness of a video teleconferencing session, for example.

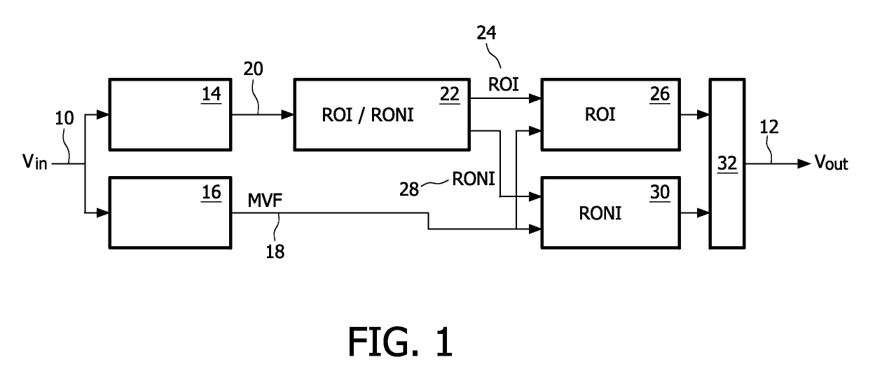

Referring to FIG. 1, the essential features of the invention are explained with regards to applying image quality enhancement to a one person video conferencing session, for instance. At the transmit end, a “video in” 10 signal (Vᵢₙ) is input into a camera and becomes the recorded camera signal. A “video out” 12 signal, on the other hand, is the signal Vₒᵤₜ that will be coded and transmitted. In other words, at the receive end, the signal 10 is the received and decoded signal, and the signal 12 is sent to the display for the end users.

In order to implement the invention, an image segmentation technique needs to be applied for the selection of a ROI containing the participant of the conference call. Therefore, a face tracking module 14 can be used to find in an image an information 20 with regards to face location and size. Various face detection algorithms are well known in the art. For example, to find the face of a person in an image, a skin color detection algorithm or a combination of skin color detection with elliptical object boundary searching can be used. Alternatively, additional methods to identify a face search for critical features in the image may be used. Therefore, many available robust methods to find and apply efficient object classifiers may be integrated in the present invention.

Subsequent to identifying the face of a participant in the image, a motion estimation module 16 is used to calculate motion vector fields 18. Thereafter, using information 20 with regards to face location and size, a ROI/RONI segmentation module 22 is performed around the participant, for example, using a simple head and shoulder model. Alternatively, a ROI may be tracked using motion detection (not motion estimation) on a block-by-block basis. In other words, an object is formed by grouping blocks in which motion have been detected with the ROI being the object with the most moving blocks. Additionally, methods using motion detection saves computational complexity for image processing technologies.

Next, a ROI/RONI processing takes place. For a ROI segment 24, the pixels are visually emphasized within the ROI segment 24 by a temporal frame rate up-conversion module 26, for visual enhancement. This is combined, for a RONI segment 28, with a temporal frame down-conversion module 30 of the remaining image portions which is to be de-emphasized. Then, the ROI and RONI processed outputs are combined in a recombining module 32 to form the “output” signal 12 (Vₒᵤₜ). Using the ROI/RONI processing, the ROI segment 24 is visually improved and brought to a more important foreground against the less relevant RONI segment 28.

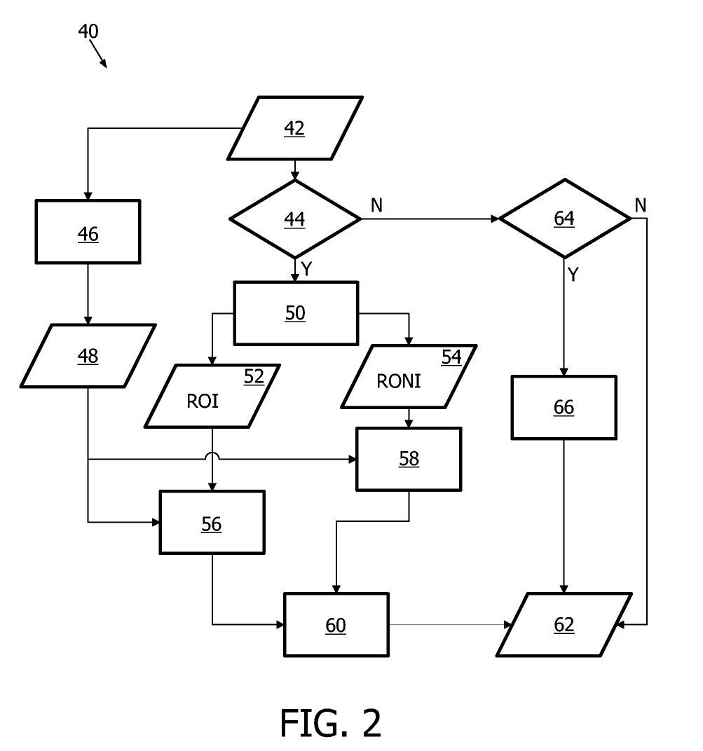

Referring now to FIG. 2, a flowchart 40 illustrates the basic steps of the invention which was described in FIG. 1. In a first “input” step 42, i.e., the video signal is input into the camera and becomes the recorded camera signal. Next, a face detection step 44 is performed in the face tracking module 14 (shown in FIG. 1), using a number of existing algorithms. Moreover, a motion estimation step 46 is carried out to generate (48) motion vectors which are later needed to either up-convert or down-convert the ROI or RONI, respectively.

If a face has been detected in the step 44, then a ROI/RONI segmentation step 50 is performed, which results in a generating step 52 for a ROI segment and a generating step 54 for the RONI. The ROI segment then undergoes a motion-compensated frame up-convert step 56 using the motion vectors generated by the step 48. Similarly, the RONI segment undergoes a frame down-convert step 58. Subsequently, the processed ROI and RONI segments are combined in a combining step 60 to produce an output signal in a step 62. Additionally, in the face detection step 44, if no face has been detected, then, in a step 64 (test “conversion down?”), if the image is to be subject to a down-conversion processing, then a down-conversion step 66 is performed. On the other hand, if the image is to be left untouched, then it simply follows on to the step 62 (direct connection), without step 66, to generate an unprocessed output signal.

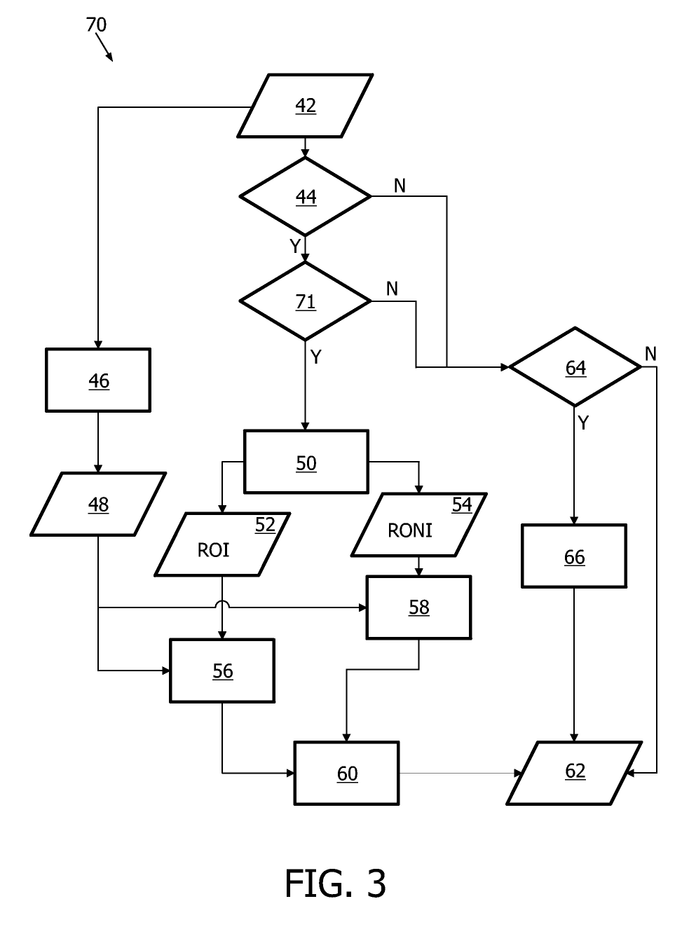

Referring now to FIGS. 3 through 5, additional optimizations to the method steps of FIG. 2 are provided. Depending on whether the participant of the video teleconference is speaking or not, the ROI up-conversion process can be modified and optimized. In FIG. 3, a flowchart 70 illustrates the same steps as in the flowchart 40 described in FIG. 2, with an additional lip detection step 71 subsequent to the face detection step 44. In other words, to identify who is speaking, one may apply lip activity detection in a video image, and speech activity detection can be measured using lip activity detection in the image sequence. For example, lip activity can be measured using conventional technology for automated lip reading or a variety of video lip activity detection algorithms. Thus, the addition of step 71 for lip activity detection mechanisms makes face tracking or detection step 44 more robust when combined with other modalities, which can be used both at transmit and receive ends. This way, the aim is to visually support the occurrence of speech activity by giving the ROI segment an increased frame rate only if the person or participant is speaking.

FIG. 3 also shows that the ROI up-conversion step 56 is only carried when the lip detection step 71 is positive (Y). If there is no lip detection, then the flowchart 70 follows on to the conversion down step 64, which ultimately leads to step 62 of generating the video-out signal.

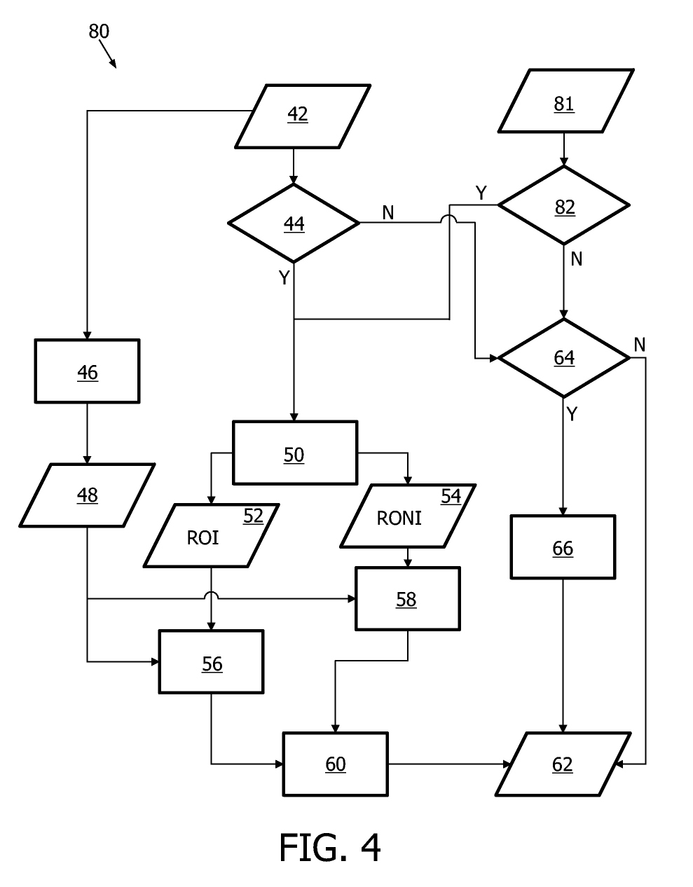

Referring now to FIG. 4, in a flowchart 80, an additional modality is implemented. As the face tracking or detection step 44 cannot be guaranteed to be always without erroneous face detections, it may identify a face where no real person is found. However, by combining the techniques of face tracking and detection with modalities such as lip activity (FIG. 3) and audio localization algorithms, the face tracking step 44 can be made more robust. Therefore, FIG. 4 adds the optimization of using an audio-in step 81 followed by an audio detection step 82, which works simultaneously in parallel with the video-in step 42 and the face detection step 44.

In other words, when audio is available because a person is talking, a speech activity detector can be used. For example, a speech activity detector based on detection of non-stationary events in the audio signal combined with a pitch detector may be used. At the transmit end, that is, in the audio-in step 81, the “audio in” signal is the microphone input. At the receive end, the “audio in” signal is the received and the decoded audio. Therefore, for increased certainty of audio activity detection, a combined audio/video speech activity detection is performed by a logical AND on the individual detector outputs.

Similarly, FIG. 4 shows that the ROI up-conversion step 56 in the flowchart 80 is only carried out when the audio detection step 82 has positively detected an audio signal. If an audio signal has been detected, then following the positive detection of a face, the ROI/RONI segmentation step 50 is performed, followed by the ROI up-conversion step 56. However, if no audio speech has been detected, then the flowchart 80 follows on to the conversion down step 64, which ultimately leads to the step 62 of generating the video-out signal.

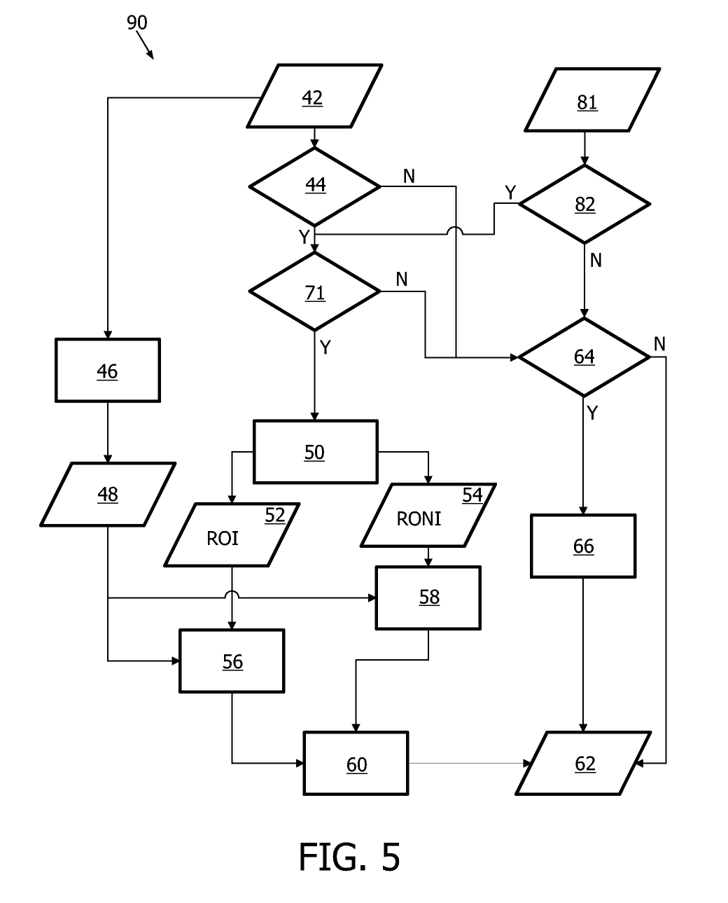

Referring to FIG. 5, a flowchart 90 illustrates the combination of implementing the audio speech activity and the video lip activity detection processes. Thus, FIG. 3 and FIG. 4 in combination results in the flowchart 90, providing a very robust means for identifying or detection the person or participant of interest and correctly analyzing the ROI.

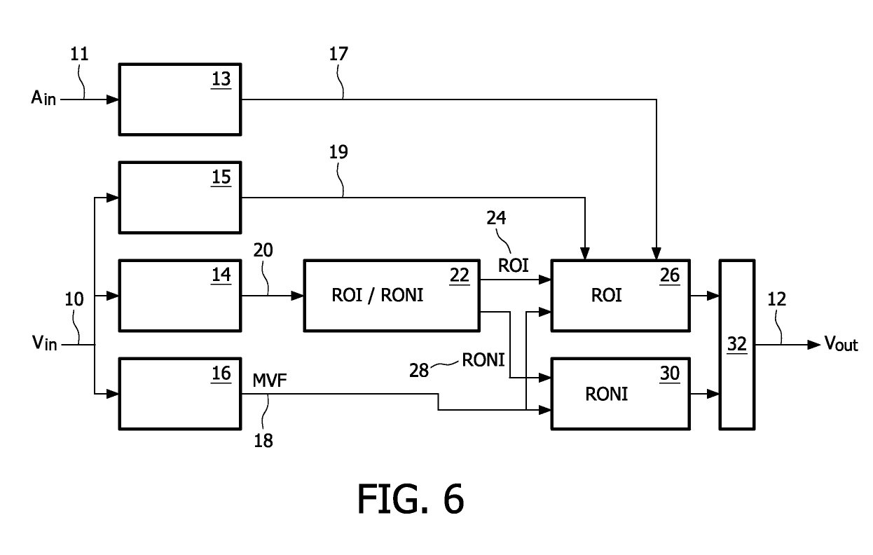

Further, FIG. 6 shows a schematic functional block diagram of the flowchart 90 for image quality enhancement applied to a one person video conferencing session implementing both audio speech detection and video lip activity detection steps. Similar to the functional features described in FIG. 1, at the transmit end, the input signal 10 (Vᵢₙ) is input into the camera/input equipment and becomes the recorded camera signal. Along the same lines, an “audio-in” input signal (Aᵢₙ) 11 is input and an audio algorithm module 13 is applied to detect if any speech signal can be detected. At the same time, a lip activity detection module 15 analyzes the video-in signal to determine if there is any lip activity in the signal received. Consequently, if the audio algorithm module 13 produces a true or false speech activity flag 17, which turns out to be true, then the ROI up-convert module 26, upon receiving the ROI segment 24, performs a frame rate up-conversion for the ROI segment 24. Likewise, if the lip activity detection module 15 detects a true or false lip activity flag 19 to be true, then upon receiving the ROI segment 24, the module 26 performs a frame rate up-conversion for the ROI segment 24.

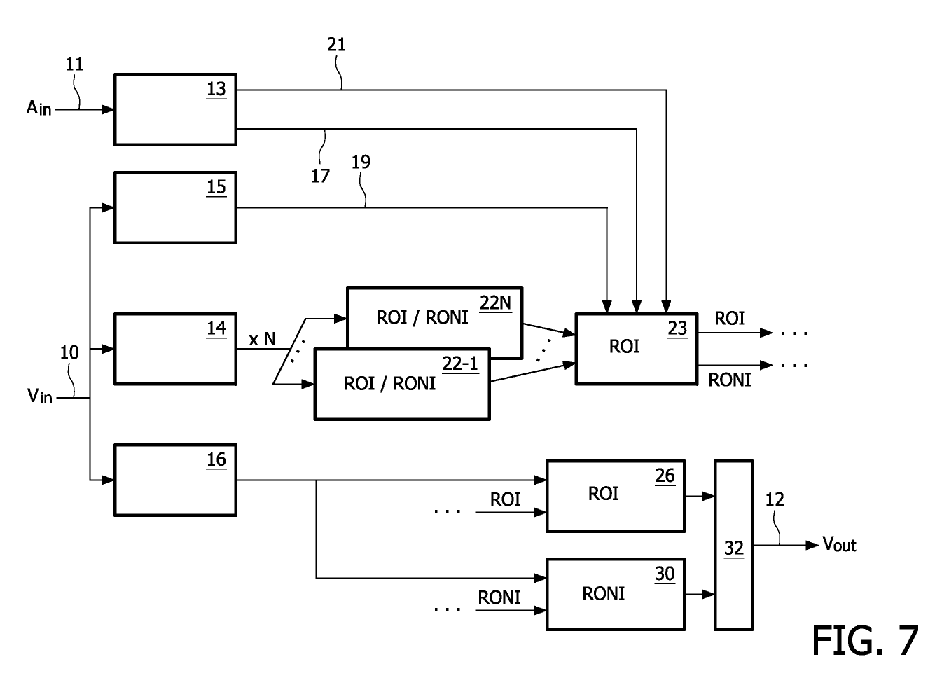

Referring now to FIG. 7, if at the transmit end, multiple microphones are available, then a very robust and efficient method to find the location of a speaking person can be implemented. That is, in order to enhance detection and identification of persons, especially identifying multiple persons or participants who are speaking, the combination of audio and video algorithms is very powerful. This can be applied when multi-sensory audio data (rather than mono audio) is available, especially at the transmit end. Alternatively, to make the system still more robust and to be able to precisely identify those who are speaking, one can apply lip activity detection in video, which can be applied both at transmit and receive ends.

In FIG. 7, a schematic functional block diagram for image quality enhancement is shown for a multiple person video telephony conference session. When at the transmit end, multiple persons or participants are present, the face tracking module 14 may find more than one face, say N in total (×N). For each of the N faces detected by the face tracking module 14, i.e., for each of the N face locations and sizes, a multiple person ROI/RONI segmentation module 22N (22-1, 22-2, . . . 22N) is generated for each of the ROI and RONI segments produced for the N faces, again, for example, based on a head and shoulder model.

In the event that two ROIs are detected, then a ROI selection module 23 performs the selection of the ROIs that must be processed for image quality enhancement based on the results of the audio algorithm module 13 which outputs the locations (x, y coordinates) of the sound source or sound sources (the connection 21 gives the (x,y) locations of the sound sources) including the speech activity flag 17, including the results of the lip activity detection module 15, namely, the lip activity flag 19. In other words, with multi-microphone conferencing systems, multiple audio inputs are available on the receive end. Then, applying lip activity algorithms in conjunction with audio algorithms, the direction and location (x, y coordinates) from which speech or audio is coming from can also be determined. This information can be relevant to target the intended ROI, who is currently the speaking participant in the image.

This way, when two or more ROIs are detected by the face tracking module 14, the ROI selection module 23 selects the ROI associated with the person who is speaking, so that this person who is speaking can be given the most visual emphasis, with the remaining persons or participants of the teleconferencing session receiving slight emphasis against the RONI background.

Thereafter, separate ROI and RONI segments undergo image processing steps by the ROI up-convert module 26 in the frame rate up-conversion for the ROI and by the RONI down-convert module 30 in the frame rate down-conversion for the RONI, using the information output by the motion estimation module 16. Moreover, the ROI segment can include the total number of persons detected by the face tracking module 14. Assuming that the persons further away from the speaker are not participating in the video teleconferencing call, the ROI can include only the detected faces or persons that are close enough by inspection of the detected face size and whose face size is larger than a certain percentage of the image size. Alternatively, the ROI segment can include only the person who is speaking or the person who has last spoken when no one else has spoken since.

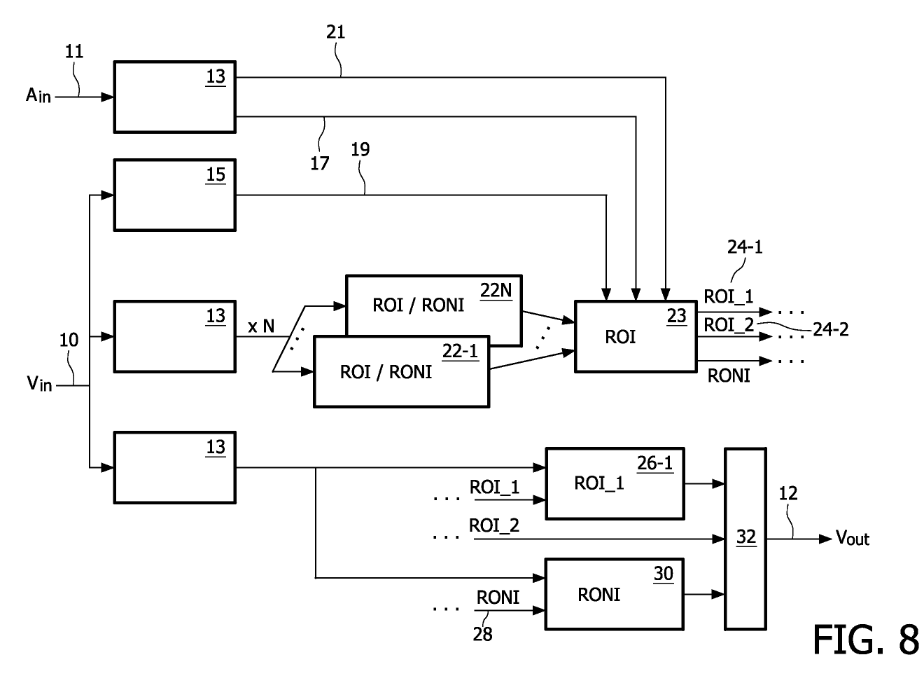

Referring now to FIG. 8, another schematic functional block illustration for image quality enhancement shown for a multiple person video conferencing session is illustrated. The ROI selection module 23 selects two ROIs. This can be caused by the fact that two ROIs have been distinguished because a first ROI segment 24-1 is associated with a speaking participant or person, and a second ROI segment 24-2 is associated with the remaining participants who have been detected. As illustrated, the first ROI segment 24-1 is temporally up-converted by a ROI_1 up-convert module 26-1, whereas the second ROI segment 24-2 is left untouched. As was the case with the previous FIGS. 5 and 6, the RONI segment 28 may also be temporally down-converted by the RONI down-convert module 30.

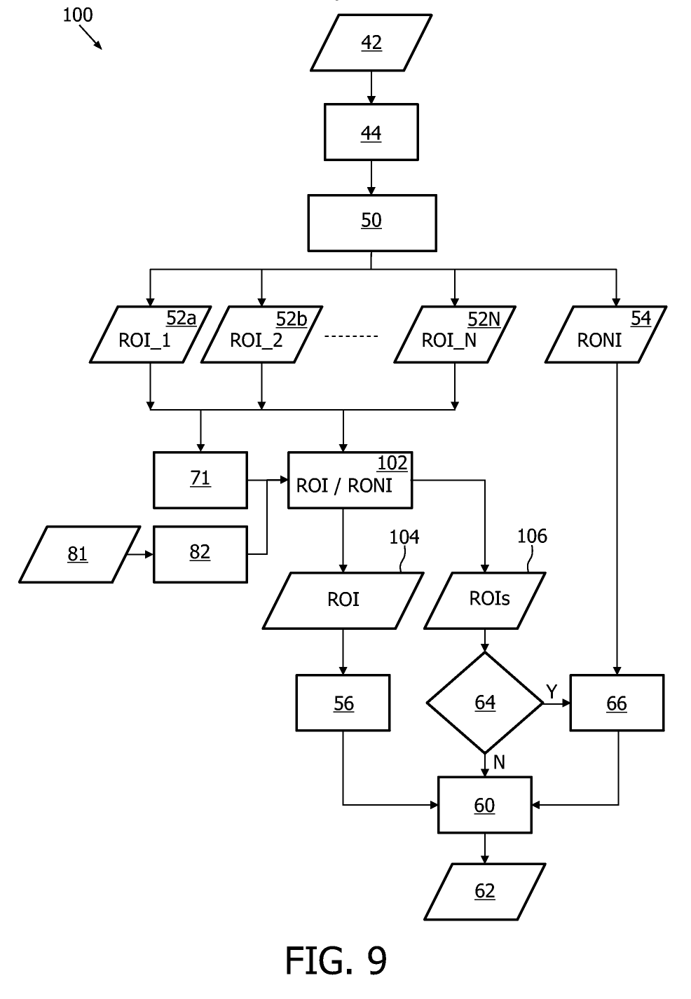

Referring to FIG. 9, a flowchart 100 illustrates the steps used in one of the embodiments of the method for image quality enhancement, as described above with reference to FIG. 8. In fact, the flowchart 100 illustrates the basic steps that are followed by the various modules which are illustrated in FIG. 8, also described with reference to FIGS. 2 through 5. Building upon these steps, in the first “video in” step 42, i.e., a video signal is input into the camera and becomes the recorded camera signal. This is followed by the face detection step 44 and the ROI/RONI segmentation step 50, which results with N number of generating steps 52 for ROI segments, and the generating step 54 for the RONI segment. The generating steps 52 for ROI segments include a step 52a for a ROI_1 segment, a step 52b for a ROI_2 segment, etc, and a step 52N for a ROI_N segment.

Next, the lip detection step 71 is carried subsequent to the face detection step 44 and the ROI/RONI segmentation step 50. As shown in FIG. 8 as well, if the lip detection step 71 is positive (Y), then a ROI/RONI selection step 102 is carried out. In a similar fashion, the “audio in” step 81 is followed by the audio detection step 82, which works simultaneously with the video-in step 42 and the face detection step 44, as well as the lip detection step 71, to provide a more robust mechanism and process to accurately detect the ROI areas of interest. The resulting information is used in the ROI/RONI selection step 102.

Subsequently, the ROI/RONI selection step 102 generates a selected ROI segment (104) that undergoes the frame up-convert step 56. The ROI/RONI selection 102 also generates other ROI segments (106), on which in the step 64, if the decision to subject the image to a down-conversion analysis is positive, then a down-conversion step 66 is performed. On the other hand, if the image is to be left untouched, then it simply follows on to the step 60 to combine with the temporally up-converted ROI image generated by the step 56 and the RONI image generated by the steps 54 and 66 to eventually arrive at the unprocessed “video-out” signal in the step 62.

Referring now to FIGS. 10-15, the techniques and methods used to achieve the image quality enhancement are described. For example, the processes of motion estimation, face tracking and detection, ROI/RONI segmentation, and ROI/RONI temporal conversion processing will be described in further detail.

Referring to FIGS. 10-12, an image 110 taken from a sequence shot with a web camera, for example, is illustrated. For instance, the image 110 may have a resolution of 176×144 or 320×240 pixels and a frame rate between 7.5 Hz and 15 Hz, which may be typically the case in today's mobile applications.

### Motion Estimation

The image 110 can be subdivided into blocks of 8×8 luminance values. For motion estimation, a 3D recursive search method may be used, for example. The result is a two-dimensional motion vector for each of the 8×8 blocks. This motion vector may be denoted by \vec{D}(\vec{X}, n) with the two-dimensional vector \vec{X} containing the spatial x- and y-coordinates of the 8×8 block, and n the time index. The motion vector field is valued at a certain time instance between two original input frames. In order to make the motion vector field valid at another time instance between two original input frames, one may perform motion vector retiming.

### Face Detection

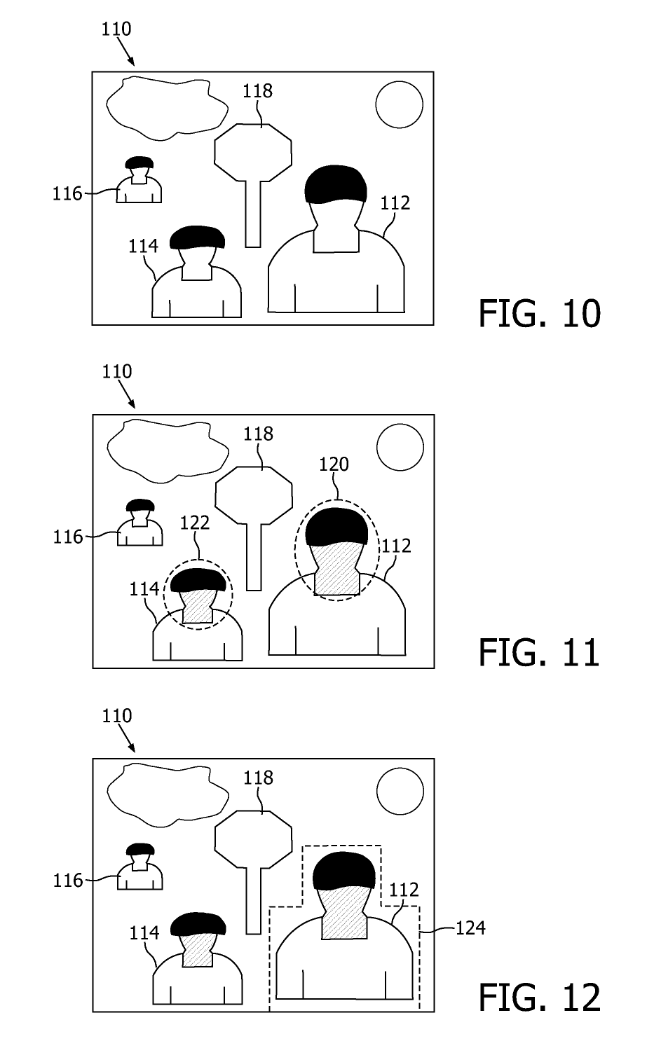

Referring now to FIG. 11, a face tracking mechanism is used to track the faces of persons 112 and 114. The face tracking mechanism finds the faces by finding the skin colors of the persons 112 and 114 (faces shown as darkened). Thus, a skin detector technique may be used. An ellipse 120 and 122 indicate the faces of persons 112 and 114 which have been found and identified. Alternatively, face detection is performed on the basis of trained classifiers, such as presented in P. Viola and M. Jones, “Robust Real-time Object Detection,” in Proceedings of the Second International Workshop on Statistical and Computational Theories of Vision—Modeling, Learning, Computing, and Sampling, Vancouver, Canada, Jul. 13, 2001. The classifier based methods have the advantage that they are more robust against changing lighting conditions. In addition, only faces which are nearby the found faces may be detected as well. The face of a person 118 is not found because of the size of head is too small compared to the size of the image 110. Therefore, the person 118 is correctly assumed (in this case), as not participating in any video conference call.

As mentioned previously, the robustness of the face tracking mechanism can be ameliorated when a face tracking mechanism is combined with information from a video lip activity detector, which is usable both at the transmit and receive ends, and/or combined with an audio source tracker, which requires multiple microphone channels, and implemented at the transmit end. Using a combination of these techniques, non-faces which are mistakenly found by the face tracking ah ?mechanism can be appropriately rejected.

### ROI and RONI Segmentation

Referring to FIG. 12, a ROI/RONI segmentation process is applied to the image 110. Subsequent to the face detection process, with each detected face in the image 110, the ROI/RONI segmentation process is used based on a head and shoulder model. A head and shoulder contour 124 of the person 112 that includes the head and the body of the person 124 is identified and separated. The size of this rough head and shoulder contour 124 is not critical but it should be sufficiently large to ensure that the body of person 112 is entirely included within the contour 124. Thereafter, a temporal up-conversion is applied to the pixels in this ROI only, which is also the area within the head and shoulder contour 124.

### ROI and RONI Frame Rate Conversion

The ROI/RONI frame rate conversion utilizes a motion estimation process based on the motion vectors of the original image.

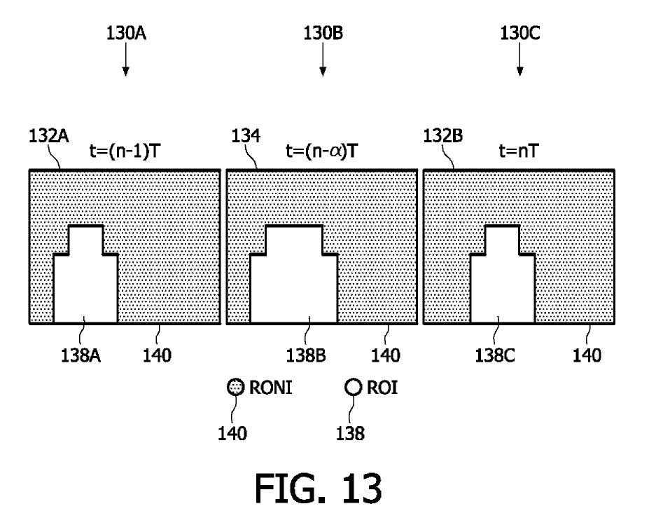

Referring now to FIG. 13, for example, in the three diagrams 130A-130C for original input images or pictures 132A (at t=(n−1) T) and 132B (at t=nT), the ROI/RONI segmentation based on the head and shoulder model as described with reference to FIG. 12 is shown. For an interpolated picture 134 (t=(n−α)T ; diagram 130B), a pixel at a certain location belongs to the ROI when at the same location, the pixel in the preceding original input picture 132A belongs to the ROI of that picture, or at the same location, the pixel in the following original input picture 132B belongs to the ROI of that picture, or both. In other words, the ROI region 138B in the interpolated picture 134 includes both the ROI region 138A and ROI region 138C, of the previous and next original input pictures 132A and 132B, respectively.

As for the RONI region 140, for the interpolated picture 134, the pixels belonging to the RONI region 140 are simply copied from the previous original input picture 132A, and the pixels in the ROI are interpolated with motion compensation.

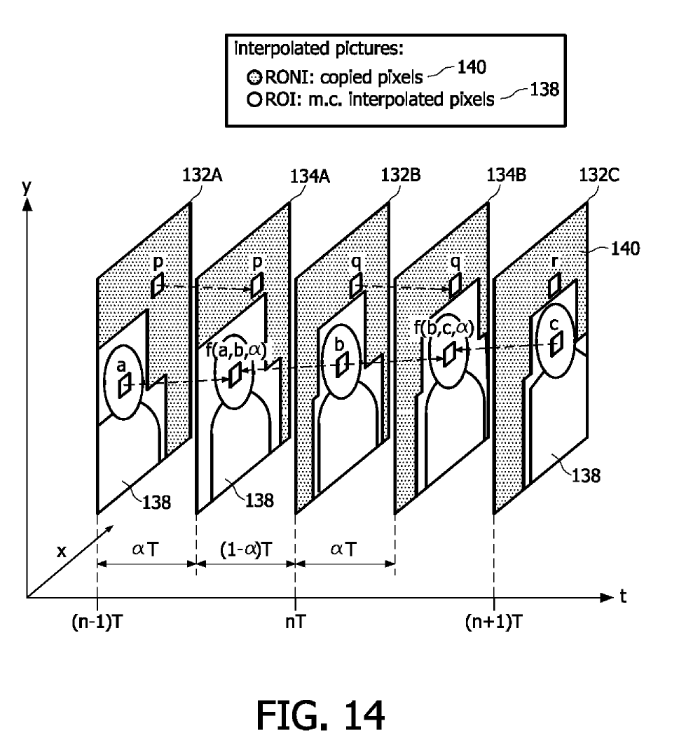

This is further demonstrated with reference to FIG. 14, where T represents the frame period of the sequence and n represents the integer frame index. For example, the parameter α (0<α<1) gives the relative timing of the interpolated image 134A between the two original input images 132A and 132B, for example (in this case, α=½ can be used).

In FIG. 14, for the interpolated picture 134A (and similarly for the interpolated picture 134B), for instance, the pixel blocks labeled “p” and “q” lie in the RONI region 140 and the pixels in these blocks are copied from the same location in the original picture before. For the interpolated picture 134A, the pixel values in the ROI region 138 are calculated as a motion compensated average of one or more following and preceding input original pictures (132A, 132B). In FIG. 14, a two-frame interpolation is illustrated. The f(a, b, α) resembles the motion compensated interpolation result. Different methods for motion compensated interpolation techniques can be used. Thus, FIG. 14 shows a frame rate conversion technique where pixels in the ROI region 138 are obtained by motion compensated interpolation, and pixels in the RONI region 140 are obtained by frame repetition.

Additionally, when the background of an image or picture is stationary, the transition boundaries between the ROI and RONI regions are not visible in the resulting output image because the background pixels within the ROI region are interpolated with the zero motion vector. However, when the background moves which is oftentimes the case with digital cameras (e.g., unstable hand movements), the boundaries between the ROI and the RONI regions become visible because the background pixels are calculated with motion compensation within the ROI region while the background pixels are copied from a previous input frame in the RONI region.

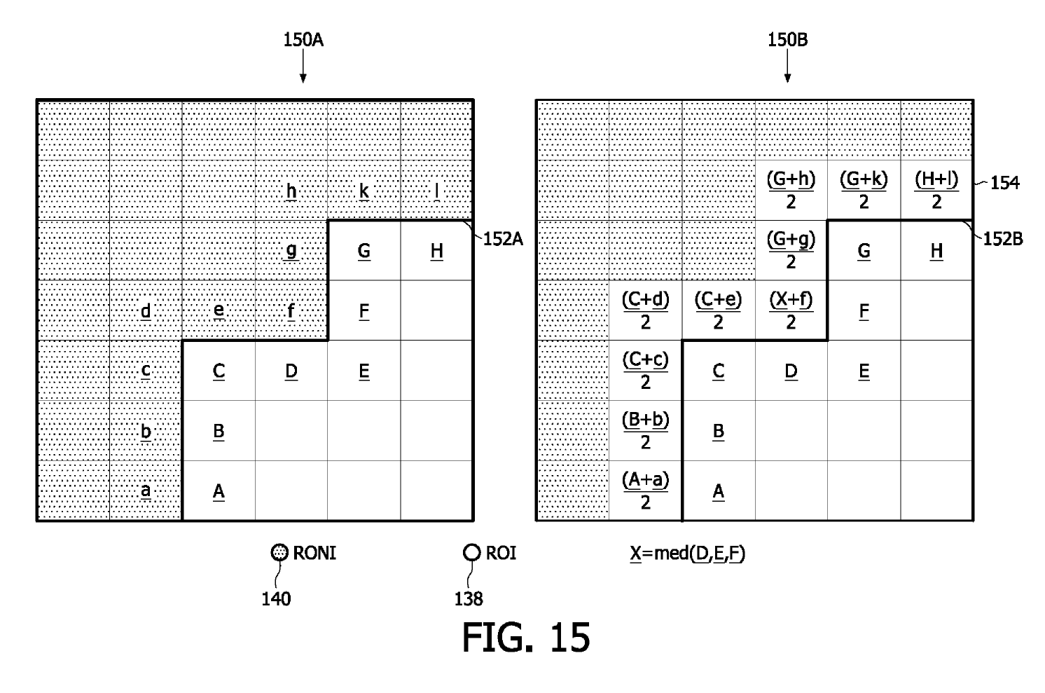

Referring now to FIG. 15, when the background is not stationary, an optimization technique can be implemented with regards to the enhancement of image quality in boundary areas between the ROI and RONI regions, as illustrated in diagrams 150A and 150B.

In particular, FIG. 15 shows the implementation of motion vector field estimated at t=(n−α)T with ROI/RONI segmentation. The diagram 150A illustrates the original situation where there is movement in the background in the RONI region 140. The two-dimensional motion vectors in the RONI region 140 are indicated by lower case alphabetical symbols (a, b, c, d, e, f, g, h, k, 1) and the motion vectors in the ROI region 138 are represented by capital alphabetical symbols (A, B, C, D, E, F, G, H). The diagram 150B illustrates the optimized situation where the ROI 138 has been extended with linearly interpolated motion vectors in order to alleviate the visibility of the ROI/RONI boundary 152B once the background begins to move.

As shown in FIG. 15, the perceptual visibility of boundary region 152B can be alleviated by extending the ROI region 138 on the block grid (diagram 150B), and making a gradual motion vector transition and applying motion-compensated interpolation analysis for the pixels in the extension area as well. In order to further de-emphasize the transition when there is motion in the background, one can apply a blurring filter (for example [1 2 1]/4) both horizontally and vertically for the pixels in a ROI extension area 154.

While there has been illustrated and described what are presently considered to be the preferred embodiments of the present invention, it will be understood by those of ordinary skill in the art that various other modifications may be made, and equivalents may be substituted, without departing from the true scope of the present invention.

In particular, although the foregoing description related mostly to video teleconferencing, the image quality enhancement method described can be applied to any type of video application, such as in those implemented on mobile telephony devices and platforms, home office platforms such as PC, and the like.

Additionally, many advanced video processing modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims and their equivalents.

1. A method for processing video images, comprising:
detecting at least one person in an image of a video application;
estimating a motion associated with the at least one detected person in the image;
segmenting the image into at least one region of interest and at least one region of no interest, wherein the at least one region of interest comprises the at least one detected person in the image; and
applying a temporal frame processing to a video signal including the image by using a higher frame rate in the at least one region of interest than that applied in the at least one region of no interest.

2. The method according to claim 1, wherein said temporal frame processing comprises a temporal frame-up conversion processing applied to the at least one region of interest.

3. The method according to claim 1, wherein said temporal frame processing comprises a temporal frame down-conversion processing applied to the at least one region of no interest.

4. The method according to claim 3, further comprising combining an output information from the temporal frame up-conversion processing with an output information from the temporal frame down-conversion processing to generate an enhanced output image.

5. The method according to claim 1, wherein the detecting, estimating, segmenting and applying are performed either at a transmitting end or a receiving end of the video signal associated with the image.

6. The method according to claim 1, wherein the detecting of the at least one person identified in the image of the video application comprises detecting lip activity in the image.

7. The method according to claim 1, wherein the detecting of the at least one person identified in the image of the video application comprises detecting audio speech activity in the image.

8. The method according to claim 6, wherein the applying of the temporal frame processing to the region of interest is carried out only upon detecting the lip activity and/or the audio speech activity.

9. The method according to claim 1, further comprising:
segmenting the image into at least a first region of interest and a second region of interest;
selecting the first region of interest to apply the temporal frame up-conversion processing by increasing the frame rate; and
leaving a frame rate of the second region of interest untouched.

10. The method according to claim 1, wherein the applying of the temporal frame up-conversion processing to the region of interest comprises increasing the frame rate of pixels associated with the region of interest.

11. The method according to claim 1, further comprising extending the region of interest on a block grid of the image and carrying out a gradual motion vector transition by applying a motion compensated interpolation for pixels in the extended region of interest.

12. The method according to claim 11, further comprising de-emphasizing a boundary area by applying a blurring filter vertically and horizontally for pixels in the extended region of interest.

13. A device for processing video images, comprising:
a detecting module for detecting at least one person in an image of a video application;
a motion estimation module for estimating a motion associated with the at least one detected person in the image;
a segmenting module for segmenting the image into at least one region of interest and at least one region of no interest, wherein the at least one region of interest comprises the at least one detected person in the image; and
at least one processing module for applying a temporal frame processing to a video signal including the image by using a higher frame rate in the at least one region of interest than that applied in the at least one region of no interest.

14. The device according to claim 13, wherein the processing module comprises a region of interest up-convert module for applying a temporal frame-up conversion processing to the at least one region of interest.

15. The device according to claim 13, wherein the processing module comprises a region of no interest down-convert module for applying a temporal frame-down conversion processing to the at least one region of no interest.

16. The device according to claim 15, further comprising a combining module for combining an output information derived from the region of interest up-convert module with an output information derived from the region of no interest down-convert module.

17. The device according to claim 1, further comprising a lip activity detection module.

18. The device according to claim 1, further comprising an audio speech activity module.

19. The device according to claim 1, further comprising a region of interest selection module for selecting a first region of interest for temporal frame up-conversion.

20. A computer-readable medium having executable instructions stored thereon which, when executed by a microprocessor cause the processor to:
detect at least one person in an image of a video application;
estimate a motion associated with the at least one detected person in the image;
segment the image into at least one region of interest and at least one region of no interest,
wherein the at least one region of interest comprises the at least one detected person in the image; and
apply a temporal frame processing to a video signal including the image by using a higher frame rate in the at least one region of interest than that applied in the at least one region of no interest.
